(19) United States
(12) Patent Application Publication
(10) Pub. No.: US 2013/0078386 A1
(43) Pub. Date: Mar. 28, 2013

(54) METHOD OF ELECTRIC FIELD ASSISTED DEPOSITION OF DNA ON POLYMER SURFACES

(71) Applicants: JunHwan RYU, Seoul (KR); Jonathan Sokolov, Stony Brook, NY (US)

(72) Inventors: JunHwan RYU, Seoul (KR); Jonathan Sokolov, Stony Brook, NY (US)

(73) Assignee: JunHwan RYU, Seoul (KR)

(21) Appl. No.: 13/278,054

(22) Filed: Oct. 20, 2011

(30) Foreign Application Priority Data
Sep. 28, 2011 (KR) 10-2011-0098279

(51) Int. Cl. B05D 7/24

(52) U.S. Cl. 427/457

(57) ABSTRACT

In the present invention, an electric field is created in the DNA solution while DNA is deposited on a polymer surface. A method of electric field assisted deposition of DNA on polymer surface according to an exemplary embodiment of the present invention comprises: forming a polymethylmethacrylate (PMMA) film on a silicon wafer by spin casting; preparing a DNA solution including DNA to be deposited on the PMMA film; and depositing DNA on the PMMA film by creating an electric field in the DNA solution while the silicon wafer on which the PMMA film is formed is submerged in the DNA solution.

### CROSS-REFERENCE TO RELATED APPLICATIONS

This application claims priority under 35 U.S.C. §119 to Korean Patent Application No. 10-2011-0098279, filed on Sep. 28, 2011, in the Korean Intellectual Property Office, the disclosure of which is incorporated herein by reference in its entirety.

### TECHNICAL FIELD

The present invention relates to a method of electric field assisted deposition of DNA on polymer surfaces.

### BACKGROUND

Recently, the interaction of DNA with surfaces has been widely studied for its range of applications, including mapping, sequencing and analyzing DNAs. Adsorbing the DNA molecules in a controlled manner is critical in these applications (Bensimon, A., et al. Science Vol (265) 2096-2098 (1994)).

DNA combing is a technique that extends the DNA on the polymer surface as it is pulled into the air from the DNA solution and deposits the attached DNA on the polymer surface. Previous studies show that best results yielded on polymethylmethacrylate (PMMA) surfaces and that the adsorption had strong dependence on the pH of the DNA solution (Bensimon, A., et al. Science Vol (265) 2096-2098 (1994), Allermand, J., et al. Biophysical Journal. Vol. (73): pgs 2064-2070 (1997)).

### SUMMARY

The present invention is a method of electric field assisted deposition of DNA on polymer surface. In the present invention, an electric field is created in the DNA solution while DNA is deposited on a polymer surface.

According to an aspect of the present invention, a method of electric field assisted deposition of DNA on polymer surface is provided, which comprises: forming a polymethylmethacrylate (PMMA) film on a silicon wafer by spin casting; preparing a DNA solution including DNA to be deposited on the PMMA film; and depositing DNA on the PMMA film by creating an electric field in the DNA solution while the silicon wafer on which the PMMA film is formed is submerged in the DNA solution.

The electric field may be created between a positive electrode made of platinum wire and a negative electrode made of gold-plated silicon wafer.

The electric field may be created by an AC power supply.

It is preferable that a surface of the silicon wafer on which the PMMA film is formed is placed to face a negative electrode of two electrodes creating the electric field.

Other features and aspects will be apparent from the following detailed description, the drawings, and the claims.

### BRIEF DESCRIPTION OF THE DRAWINGS

FIG. 1 is a flowchart schematically showing a method for depositing DNA using an electric field according to an exemplary embodiment of the present invention.

FIG. 2 shows a configuration of an apparatus for electric field assisted deposition of DNA on polymer surfaces according to an exemplary embodiment of the present invention.

FIG. 3 shows a movement direction of DNA in the apparatus for depositing DNA using an electric field according to the exemplary embodiment of the present invention.

FIGS. 4A to 4D are bar graphs showing the density of DNA deposited with different DNA concentration and different electric field.

FIG. 5 is a graph of DNA density vs. DNA concentration at different electric fields.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, a method of electric field assisted deposition of DNA on polymer surfaces according to an exemplary embodiment of the present invention will be described in detail with reference to the accompanying drawings.

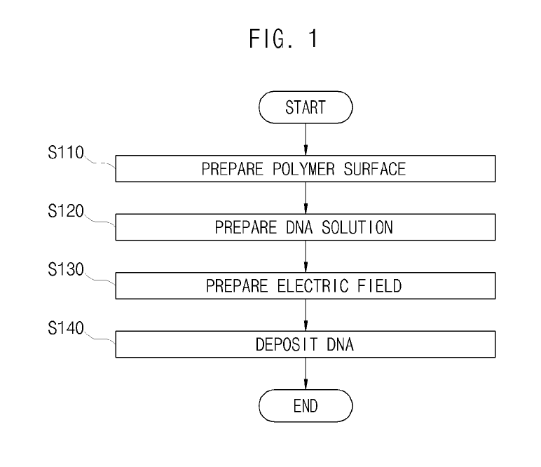

FIG. 1 is a flowchart schematically showing a method of electric field assisted deposition of DNA on polymer surfaces according to an exemplary embodiment of the present invention.

In the method of electric field assisted deposition of DNA on polymer surfaces according to the exemplary embodiment of the present invention, as shown in FIG. 1, a PMMA coated silicon wafer is first prepared (S110), and DNA solution for deposition of DNA on the polymer surface is prepared (S120).

Next, the electric field to be created during deposition of DNA is prepared (S130). After the electrodes for creating the electric field are set up, DNA is deposited on the polymer surface while the electric field is turned on (S140).

Hereinafter, steps shown in FIG. 1 will be described in more detail.

### (1) Preparation of the Polymer Surface

First, approximately 10×10 mm silicon wafers are cut using diamond cutters. After cutting, the silicon dusts from the cleavage are removed using nitrogen gas. In order to clean off organic contamination, the wafers are submerged in methanol or ethanol, sonicated for 15 minutes and then sonicated for at least 15 minutes again in a solution of 3:1 0.1M sulfuric acid: 0.1M hydrogen peroxide. Then the wafers are triple rinsed with deionized (DI) water.

After cleaning, polymethylmethacrylate (PMMA) thin film is created on top of the silicon wafers by spin casting. Each wafer is spun three times at 2.38×10² RPM, 7.2V for 1 minute: once without any substances for drying the DI water on the silicon wafer, once with pure toluene in order to dissolve impurities on the surface of the wafer, and last time with 15 mg/ml of PMMA dissolved in toluene. The thickness of the PMMA can be measured with an ellipsometer (Rudolf Auto EL) to be in the range of 600 to 800 Å. Then, the wafers are annealed for at least 60 minutes at 105° C. with pressure at most 1×10⁷ torr in ion pump vacuum oven (Perkin Elmer).

### (2) Preparation of DNA Solution

Lambda(λ)—DNAs are dyed with YoYo-1 by making a solution of 10% stock DNA solution, 10% YoYo-1 (invitrogen), and 80% buffer solution and then incubating in a 45° C. heat oven for 120 minutes. The buffer solution used for the DNA solution is a solution of 0.1M sodium hydroxide (NaOH) and 20 mM 2-(N-morpholino)ethanesulfonic acid (MES) mixed at at 6:50 NaOH:MES volume ratio. Different concentration of DNA were tested by diluting the 10% DNA solution farther with the 6:50 NaOH:MES solution during the experiments. The solution was vortexed after every mixture and dilution.

### (3) Preparation of Electric Field

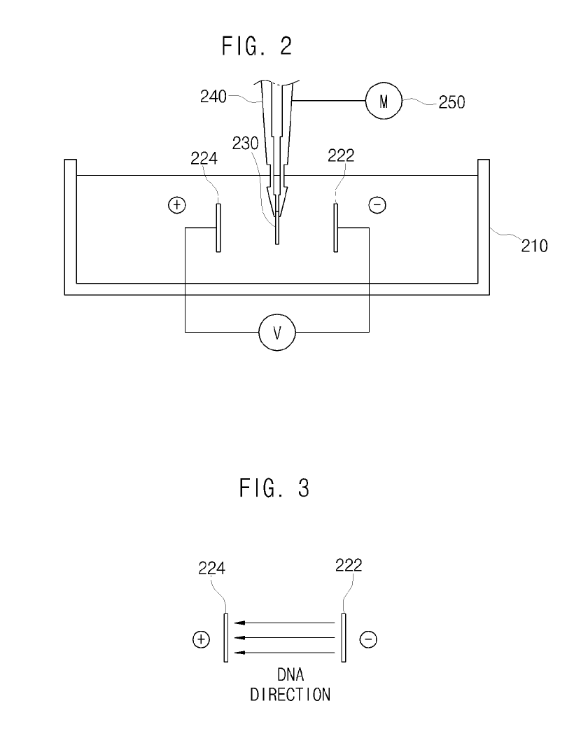

FIG. 2 shows a configuration of an apparatus for electric field assisted deposition of DNA on polymer surfaces according to an exemplary embodiment of the present invention.

As shown in FIG. 2, a cell for the electrochemical experiments was made with two electrodes 222 and 224 and a Teflon well 210.

As the electrodes 222 and 224, platinum wires and gold-plated silicon wafers are used, respectively. The gold-plated silicon wafers are cut into 6 mm×25 mm with a scribe and break apparatus.

The electrodes 222 and 224 are thoroughly cleansed with ethanol or methanol by submerging them in the chemical and rinsing three times with DI water before every experiment. Further, in order to prevent the electrodes 222 and 224 from forming oxides on the surfaces, the electrodes 222 and 224 are stored in a glass vial or covered with a foil.

A 36×11×10 mm Teflon well 210 is made for placing the DNA solution and is cleansed by sonicating for 15 minutes in methanol or ethanol, and then sonicating again in DI water for 15 minutes. Then, the electrodes 222 and 224 are set up 27.94 mm (1.1 inch) apart at the long end of the Teflon well and held in place with screws. Further, the electrodes 222 and 224 are situated at the exact middle of the well 210, 5.5 mm away from both long sides.

Different electrodes can be used for different purposes. In order to create a more uniform electric field in the middle of the cell 210, a wider gold plated silicon wafer is used as the negative electrode 222. On the other hand, a platinum wire is used as the positive electrode 224. On the positive end, gold plate showed electrochemical reaction with the buffer solutions, while the platinum showed a much less reaction with the buffer solutions.

For alternating current (AC) electric fields, two platinum wires can be set up on either end of the cell 210.

Then, the electrodes 222 and 224 are connected to a voltage source V that would send voltage for 1.5 seconds and then create current in the opposite direction for 0.5 seconds.

For direct current (DC) electric fields from 0 to 30V, a power supply (Hewlett Packard, 6216A) is used. For higher voltages and AC electric fields, a programmable voltage source (Keithly, 228A Voltage/Current Source) is used.

When an AC electric field is used, the effects of ion build up on the electrodes and on the polymer surface can be reduced.

### (4) Deposition of DNA on Polymer Surface

The electric field assisted deposition of DNA on polymer surfaces according to an exemplary embodiment of the present invention is performed using the cell prepared in the above step (3). DNA is deposited on the PMMA-coated silicon wafer with a dipping and retracting method.

As shown in FIG. 2, the dipping apparatus consisted of Teflon tweezers 240 and a computer controlled stepper motor 250 (Arrick, MD-2 Dual Stepper Motor system) that controls the tweezers 240. With the dipping apparatus, it is possible to control various parameters of the dipping process including acceleration, velocity, a dipping time and travel distance. The cell 210 is mounted underneath the tweezers 240 so that the end points of the tweezers 240 are in the middle of the cell 210, that is, 13.97 mm (5.55 inch) apart from both electrodes 222 and 224.

The PMMA-coated silicon wafer 230 is held with the tweezers 240 so that the PMMA film faces the negative electrode 222, such that the negatively charged DNA particles would move toward the PMMA surface.

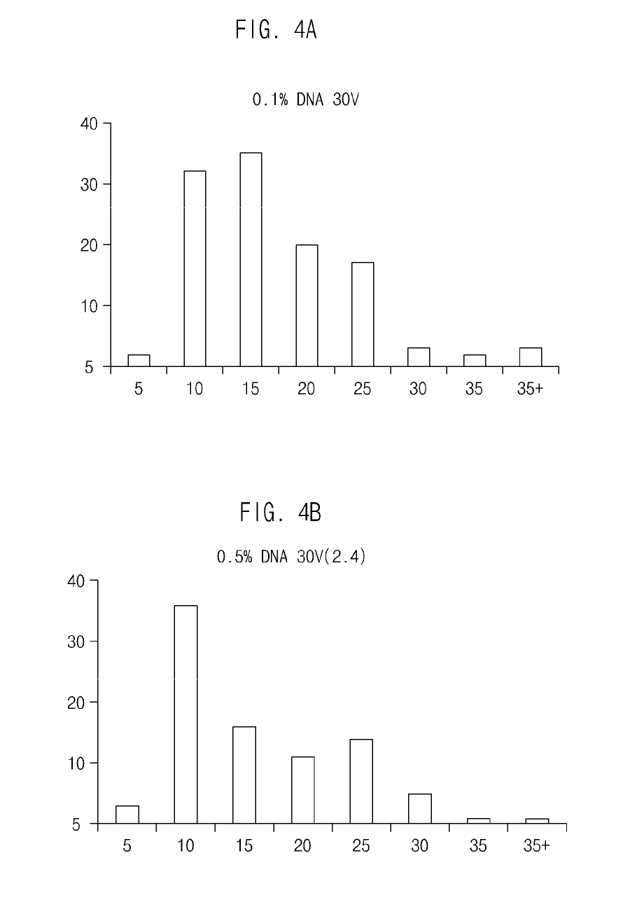

FIG. 3 shows a movement direction of DNA in the method of electric field assisted deposition of DNA on polymer surfaces according to the exemplary embodiment of the present invention. As shown in FIG. 3, since the DNA particles move toward the positive electrode 224 from the negative electrode 222, the PMMA-coated silicon wafer 230 should be placed so that the PMMA film as the polymer surface on which the DNA will be deposited faces the negative electrode 222.

The diluted DNA solution of 3000 μl is injected into the Teflon well 210 with a pipette and the wafer 230 is lowered so that most of the wafer 230 is submerged in the solution. Then, the electric field is turned on and after a certain amount of sleep time, the wafer 230 is retracted from the solution.

On the contrary, in order to take off the DNA from the polymer surface, the wafer 230 can be placed facing the opposite direction in just 6:50 NaOH:MES buffer solution without DNA.

The DNA strands dyed with YoYo-1 can be observed using a fluorescent microscope.

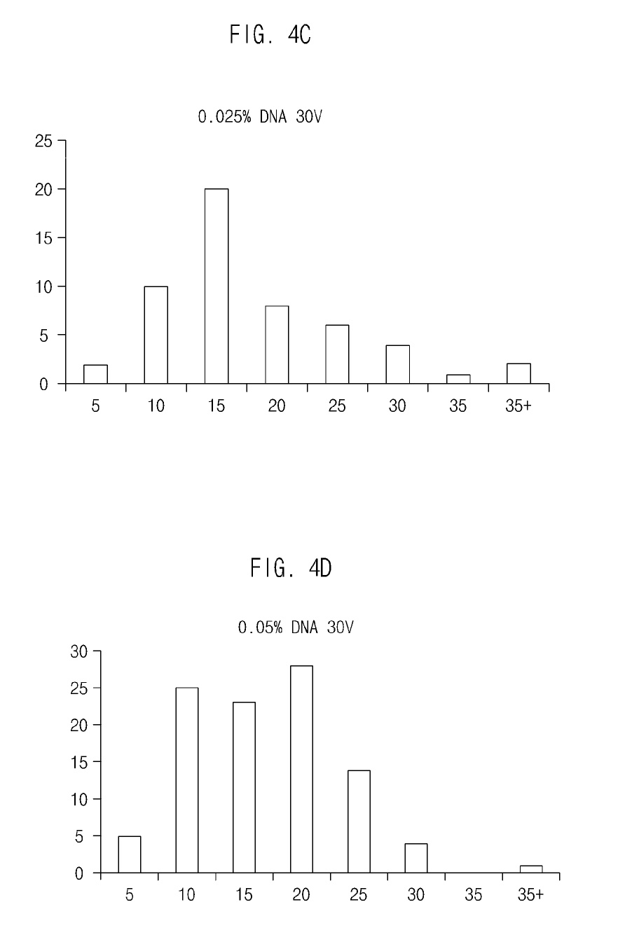

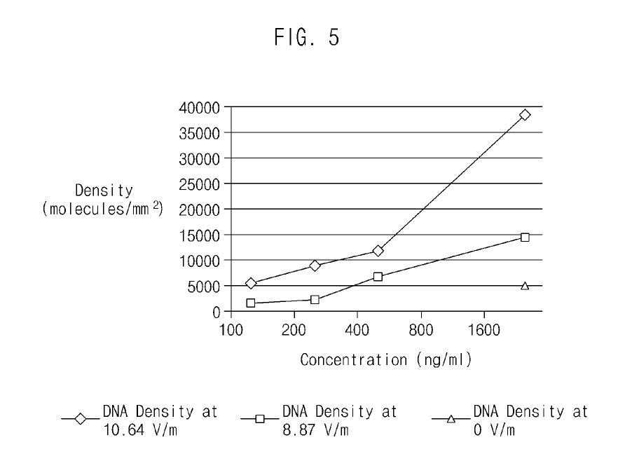

FIGS. 4A to 4D are bar graphs showing the density of DNA deposited with different DNA concentration and different electric field, and FIG. 5 is a graph of DNA density vs. DNA concentration at different electric fields.

As shown in FIGS. 4A to 5, the DNA density goes up as the electric field becomes larger. Results show that using 125 ng/ml DNA solution with electric field of 10.64V/cm for deposition yields similar density on the polymer surface as using 2.5 mg/ml DNA solution with no electric field, raising the efficiency of DNA deposition by about 20 times.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of electric field assisted deposition of DNA on polymer surface, comprising:
forming a polymethylmethacrylate (PMMA) film on a silicon wafer by spin casting;
preparing a DNA solution including DNA to be deposited on the PMMA film; and
depositing DNA on the PMMA film by creating an electric field in the DNA solution while the silicon wafer on which the PMMA film is formed is submerged in the DNA solution.

2. The method of claim 1, wherein the electric field is created between a positive electrode made of platinum wire and a negative electrode made of gold-plated silicon wafer.

3. The method of claim 1, wherein the electric field is created by an AC power supply.

4. The method of claim 1, wherein a surface of the silicon wafer on which the PMMA film is formed is placed to face a negative electrode of two electrodes creating the electric field in the depositing.
